(19) United States
(12) Patent Application Publication
(10) Pub. No.: US 2012/0148885 A1
(43) Pub. Date: Jun. 14, 2012

(54) PROTECTIVE UNIT FOR GALVANIC CELLS

(76) Inventors: Jens Meintschel, Bernsdorf (DE); Tim Schaefer, Niedersachswerfen (DE)

(21) Appl. No.: 13/145,419

(22) PCT Filed: Jan. 11, 2010
(86) PCT No.: PCT/EP10/00087

§ 371 Date: Feb. 28, 2012

(30) Foreign Application Priority Data
Jan. 20, 2009 (DE) 10 2009 005 228.3

(51) Int. Cl. H01M 2/00

(52) U.S. Cl. 429/61

(57) ABSTRACT

A protective unit for galvanic cells, which are interconnected into a battery by way of contact elements that are connected in a suitable manner to pole connections of said cells, can be associated with individual cells of a battery. The protective unit comprises an activation unit (1008, 1108, 1208, 1011, 1111) for the activation thereof. When the protective unit is activated, said protective unit bypasses the associated cell by changing the interconnection and thus takes it electrically out of the battery assembly.

Priority application DE 102009005228 is fully incorporated by reference into the present application

The invention relates to a protective unit for galvanic cells, a galvanic cell comprising such a protective cell and a battery made of such galvanic cells. Batteries consist of individual cells which are connected in series and/or in parallel and are often accommodated together with the associated electronics and cooling device in a common housing. In automotive engineering, such batteries, in particular high voltage batteries, are used, among other things, as traction battery for electric vehicles and as intermediate energy storage for hybrid vehicles. Such cells can be damaged for example by overcharging, short circuit or other causes or can be disturbed in a different manner with respect to their intended function.

For example, lithium-ion batteries are known which break the circuit in case of overcharged or short-circuited cells. For example, in case of overheating of such a cell it is known to rupture the housing of the same at a specifically weakened point, for example by means of a rupture disk and under the effect of the simultaneously increased inner pressure of the cell and thereby to disconnect the electrical contact from the electrode coil to the battery terminals. Such known solutions involve in some cases the disadvantage that by disconnecting the circuit on the cell side, the cells connected in series with the defective cell are also unable to deliver electric current. In particular in case of electric vehicles, this can result in a complete failure (“break down”). In case of hybrid vehicles—depending on the system design—it can occur, for example, that the restart of the internal combustion engine is not possible anymore.

To prevent these disadvantages, units have been proposed in which a defective cell is detached from the electric series connection and, at the same time, is bypassed. In case of such known solutions, the device for disconnecting the circuit on the cell side and for bypassing the defective cell often obtains its actuation energy from the pressure increase inside the cell. Thus, said known units take effect only after the cell is already irreversibly damaged. In such cases, content of the cell, for example a partially vaporized electrolyte, can escape which, due to its electrical conductivity, can cause further short-circuits. In such cases, repairing the battery is often no longer possible or reasonable because due to the corrosive effect of the electrolyte, the interior of the battery is attacked within a short time.

The present invention is based on the object to propose an effective protective unit for galvanic cells and, if possible, to prevent the problems associated with the known solutions. This object is solved by a protective unit for galvanic cells according to claim 1. Furthermore, the object is solved by a product according to any one of the further independent claims.

The invention provides a protective unit for galvanic cells which are interconnected into a battery via contact elements which are suitably connected to pole connections of the cell. The protective unit according to the invention is characterized in that it has an activation unit for activating the protective unit. Upon activation of the protective unit, said protective unit bypasses a cell associated with the protective unit by changing the interconnection and thus electrically detaches said cell from the battery assembly.

Terms used in connection with the description of the present invention are defined and explained below.

A galvanic cell in the meaning of the present invention is to be understood as an electrical or electrochemical cell, in particular primary cell or secondary cell, suitable for assembling a battery. Such cells are hereinafter also designated as battery cells, cells or individual cells. A battery is to be understood as an interconnection of such cells—in series and/or in parallel.

An interconnection of galvanic cells in connection with the present invention is to be understood as any technically useful combination of series and/or parallel connections of such cells. Said interconnection is established by suitably connecting the pole connections of such galvanic cells by means of contact elements, in particular by means of contact plates, conductor rails, insulators etc.

In the present context, an activation unit is to be understood as any unit for activating the protective unit according to the invention which enables a protective unit according to the invention to systematically bypass individual cells of a battery and thus to electrically detach said cells from the battery assembly. The term “electrically detach” means that the cell involved remains spatially at its position within the battery assembly but that said cell is detached from the electrical series and/or parallel connection of a plurality of cells constituting the battery by bypassing certain contacts.

For activating the protective unit by means of the activating unit, energy is needed, for example because contact elements have to be moved for this purpose. According to the invention, said energy is supplied from the outside or provided by an energy storage device which is integral part of the protective unit. This can involve energy storage devices of any possible type, in particular mechanical energy storage devices. For supplying the energy required for activating, all types of units suitable for this purpose can be considered, in particular electromagnetic transducers such as, for example, electromagnetic switches (relays, etc.) which are operated by means of energy supplied from outside, thus, for example, is drawn from the battery assembly, the rest of the cells of which remains continuously functional.

Advantageous developments of the invention form the subject matter of sub-claims.

The invention is described in more detail hereinafter based on preferred exemplary embodiments and by means of figures. In the figures:

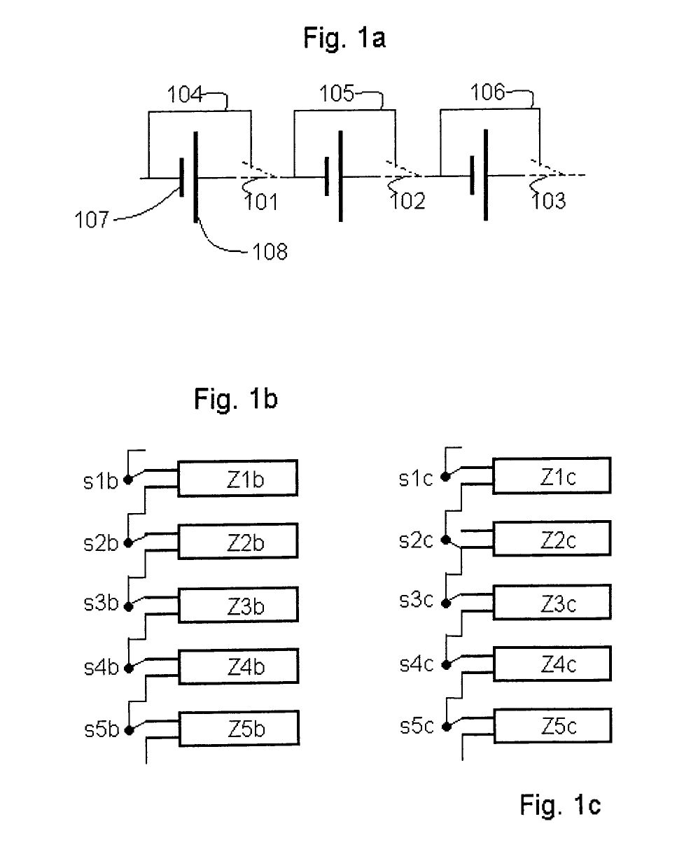

FIG. 1a shows a wiring diagram of a series connection of battery cells which each have an actively controllable cell-side unit according to a preferred embodiment for detaching or bypassing cells which are electrically connected in series;

FIG. 1b shows an interconnection of battery cells with the switches of a protective unit in which all switches are in a position which effects a series connection of all battery cells;

FIG. 1c shows an interconnection of battery cells in which one switch is in a position which results in bypassing a battery cell and thus in detaching the same from the battery assembly;

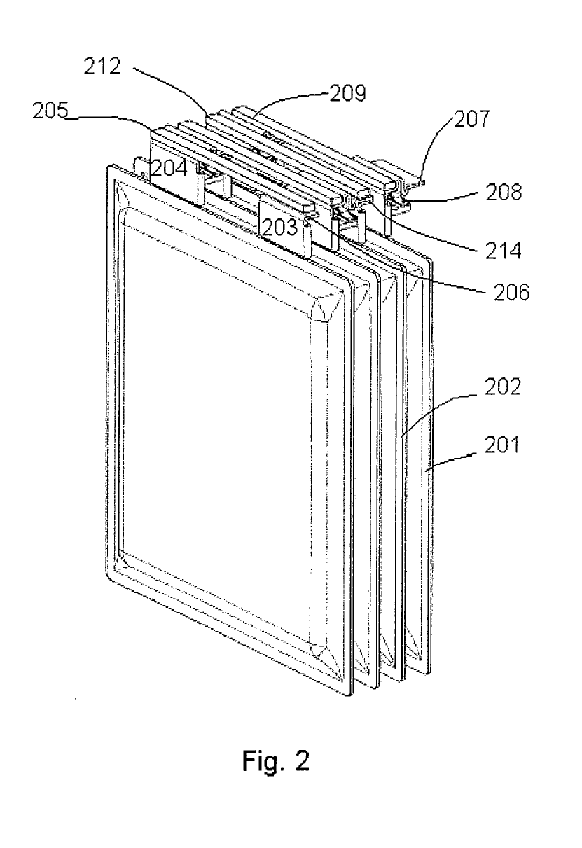

FIG. 2 shows an interconnection of battery cells having protective units according to a preferred embodiment of the invention;

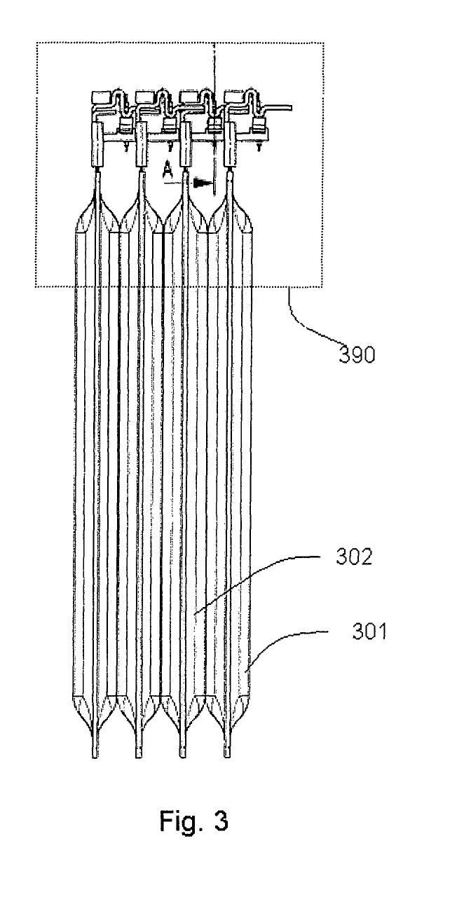

FIG. 3 shows a side view of a cell block having protective units according to a preferred embodiment of the present invention;

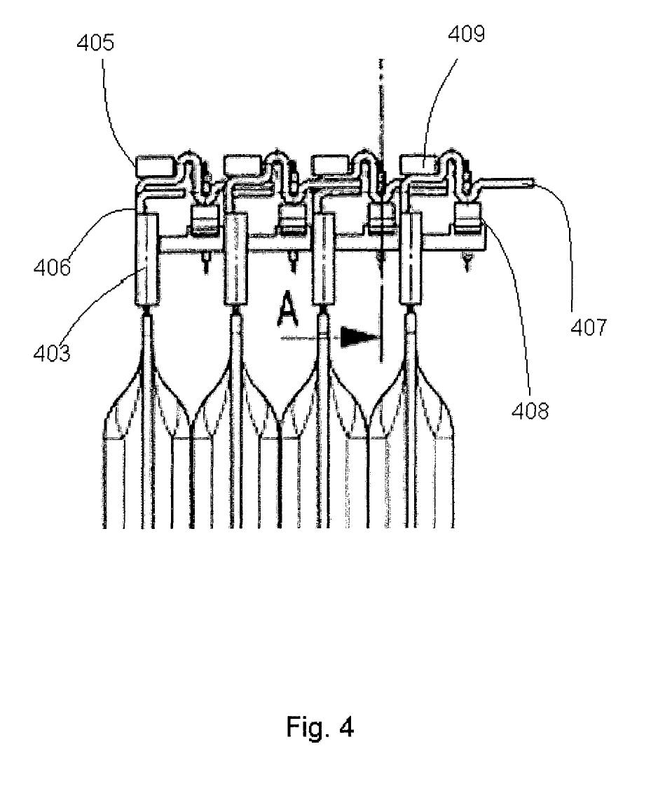

FIG. 4 shows an enlarged illustration of the upper part of the cell block illustrated in FIG. 3 which has a protective unit according to a preferred embodiment of the present invention;

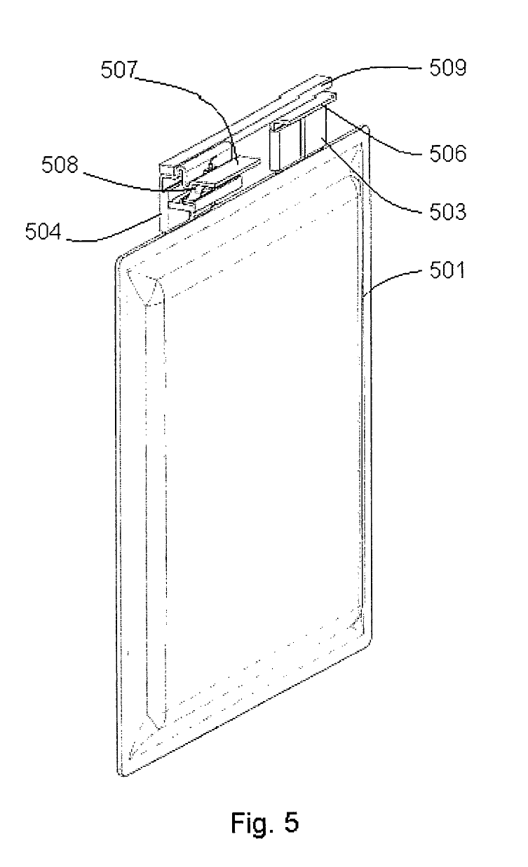

FIG. 5 shows the view of a cell having a protective unit according to a preferred exemplary embodiment of the present invention;

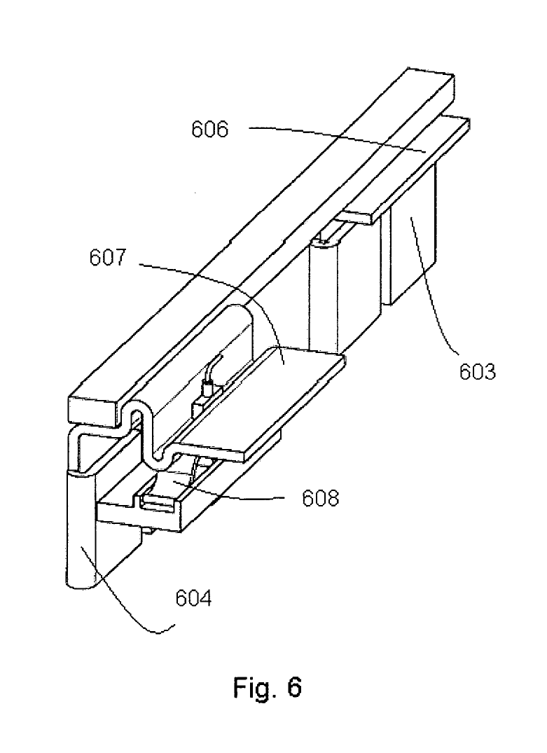

FIG. 6 shows a detailed view of a protective unit according to a preferred embodiment of the invention;

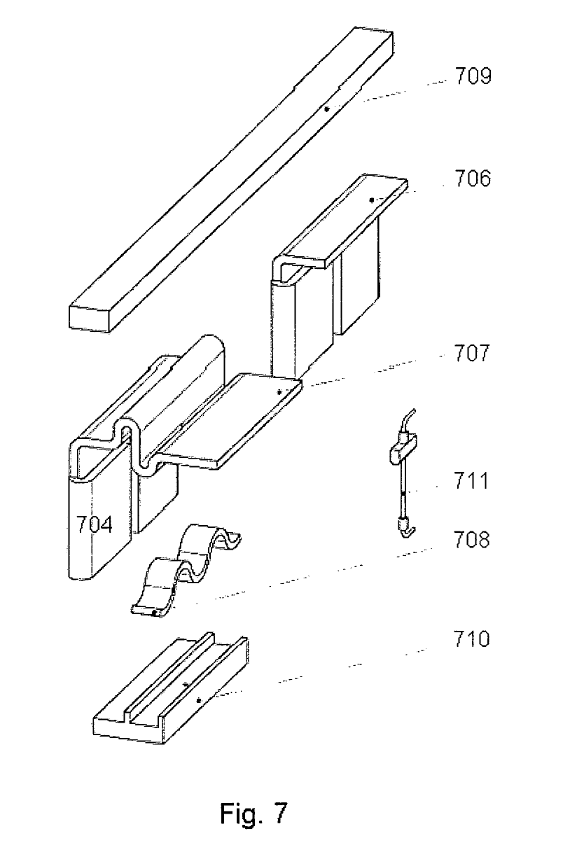

FIG. 7 shows an exploded view of the embodiment shown in FIG. 6;

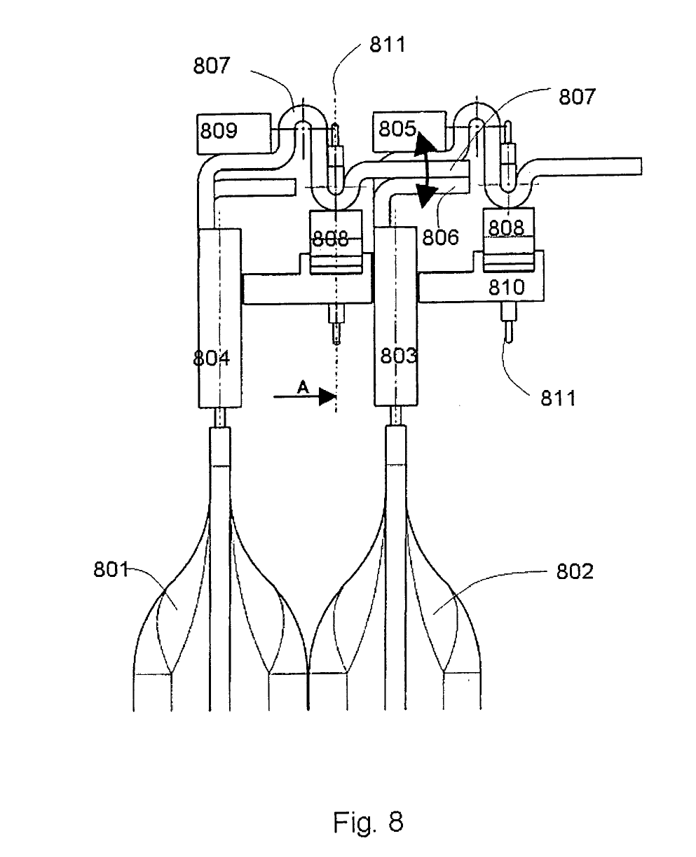

FIG. 8 shows a side view of a protective unit according to a preferred embodiment of the invention in the non-activated state (normal operation);

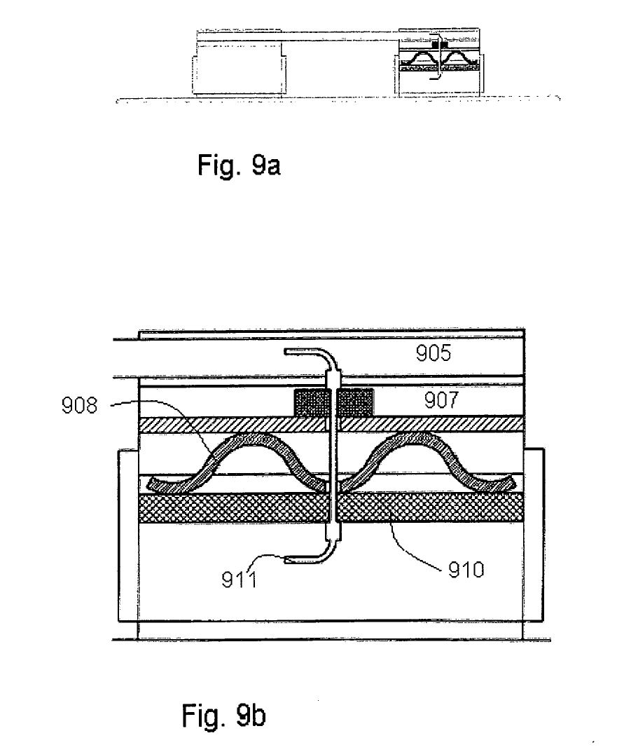

FIG. 9a shows a protective unit according to a preferred embodiment of the invention;

FIG. 9b shows an enlargement of the right part of the embodiment illustrated in FIG. 9a in the non-active state (normal operation);

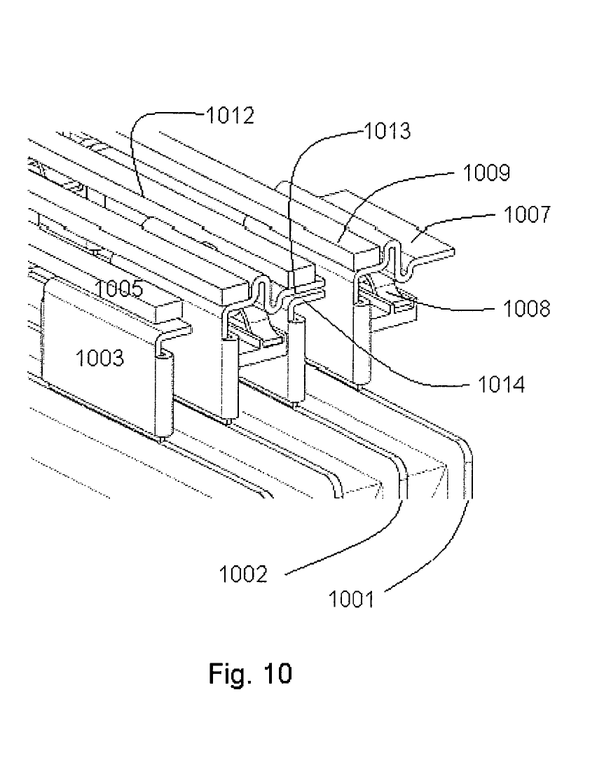

FIG. 10 shows a view of a cell block with activated protective unit according to a preferred embodiment of the present invention;

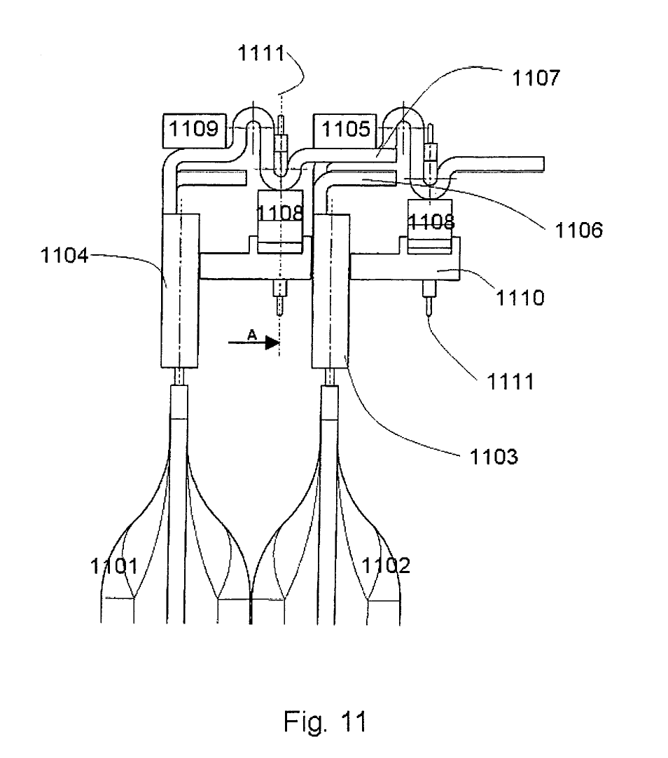

FIG. 11 shows a side view of an activated protective unit according to a preferred embodiment of the present invention;

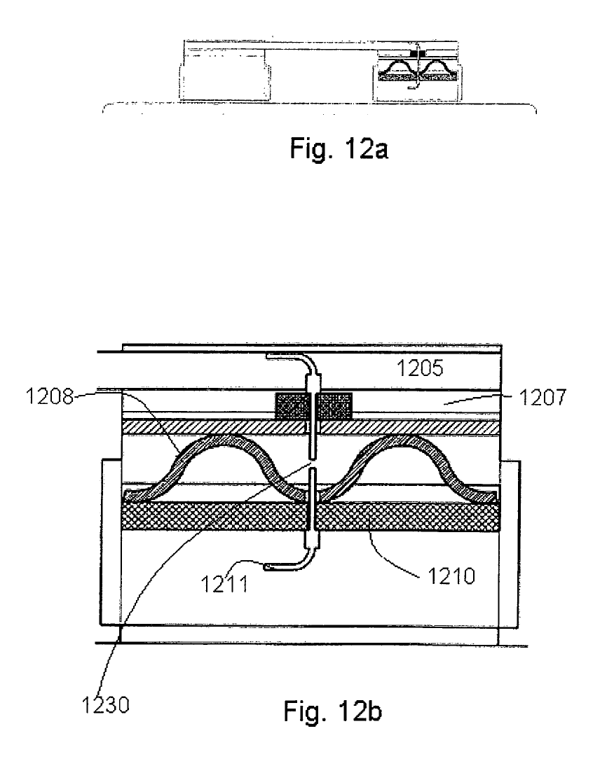

FIG. 12a shows a sectional view of a protective unit according to a preferred embodiment of the invention in the case of an activated protective unit, and

FIG. 12b shows an enlarged illustration of the right part of the embodiment of an activated protective unit illustrated in FIG. 12a.

As illustrated in FIG. 1a, the principle of the mode of operation of a protective unit according to the invention is to systematically detach a defective cell from an interconnection of a plurality of cells by bypassing. For this, bypasses 104, 105, 106 are provided which in the case of activation of one of the switches 101, 102, 103 connect an electrode 107 to the like electrode of an adjacent cell. In the non-activated state of the protective unit, however, the electrode 108 is connected to the electrode of the adjacent cell which is unlike with respect to the latter. In a similar manner, FIGS. 1b and 1c show the principle of the mode of operation of the protective unit according to the invention. Since in FIG. 1b, all switches S1b, S2b, . . . , S5b are in a corresponding equal position, FIG. 1b shows a series connection of the cells Z1b, Z2b, . . . , Z5b. In FIG. 1c, the switch S2c is in the activated position, whereby the cell Z2c is detached from the interconnection.

As illustrated in FIG. 2, the interconnection of battery cells is carried out by means of contact elements. Examples for such contact elements are the conductor rails 205, 209 and 212 illustrated in FIG. 2. The electrodes (arresters) 203 and 204 are suitably connected or, respectively, not connected to these contact elements. The protective unit according to the invention is preferably arranged in each case between the strip-shaped poles (“arresters”) of two adjacent cells. The actuation energy for activating the protective unit is stored, for example, in a wave spring 208 which is retained in its initial position by a fuse wire 711, 811, 911 shown in the FIGS. 7 and 9. In case of a beginning malfunction, said fuse wire is melted by a current pulse and the wave spring 208, 708, 908 shown in the FIGS. 2, 7 and 9 lifts the movable conductor rail which previously was the electrical series connection so as to form sub-cells and presses said conductor cell against a second conductor cell which electrically bypasses the defective cell.

According to a preferred embodiment of the present invention, the protective unit according to the invention is equipped with an energy storage device which stores the energy required for changing the interconnection and makes it available upon activation. This can involve mechanical energy storage devices or other energy storage devices, for example chemical or electrical energy storage devices. An energy storage device 208, 408, 508, 608, 708, 808, 908, 1008, 1108, 1208 which is structured in a simple manner is illustrated in the FIGS. 2, 4, 5, 6, 7, 8, 9, 10, 11 and 12. A wave spring 208, 408, 508, 608, 708, 808, 908, 1008, 1108, 1208 is retained from below by a bearing 210, 310, 910, 1010, 1110. A fuse wire 711, 811, 911, 1111 keeps said wave spring in its initial position and initial shape, thus in the tensioned state. Once the wire melts, the wave spring lifts the contact plate 207, 407, 607, 707, 807, 907, 1007, 1207 and presses it against the conductor rail 1105, 1205. The contact to the contact plate 1106 is interrupted. Thus, bypassing the cell is carried out.

The protective unit is preferably accommodated in a housing which is not illustrated in the figures. To prevent corrosion, said housing is preferably sealed in an air-tight manner and filled with an inert shielding gas, if needed.

Preferably, the protective unit according to the invention can be actively and individually controlled for each cell and thus can individually detach the respective defective cell from the circuit and bypass said cell. If, for example, the battery electronics detects a beginning malfunction of a cell by monitoring the cell voltage and/or the cell temperature, the unit can be preventively triggered. The battery remains operational with an insignificantly reduced voltage level.

The solutions according to the invention by means of which the energy for activating is not taken from a process which is involved with the malfunction or the destruction of the respective cell to be bypassed, but is supplied from outside the protective unit or taken from an energy storage device which is preferably integral part of the protective unit or the activation unit are associated with the advantage that a cell affected by a malfunction can be electrically detached from the battery assembly already at an early stage at which the destruction of the cell has not started yet or has even advanced to such an extent that the energy required for activating the protective unit could be taken from the destruction process. In many cases, a destruction of the cell can be avoided in this manner. Under favorable conditions it is possible that a bypassed cell recovers after a certain time and can be integrated again in the battery assembly.

Assuming that the activation of the protective unit takes place early enough, it is even possible that the cell to be bypassed is still able to supply the energy for activating its protective unit. Thus, it can act as energy storage unit of the protective unit before it is electrically detached from the battery assembly by bypassing.

Depending on the actual use, a protective unit according to the invention is equipped with an activation unit which can be activated by a signal which is generated inside or outside the protective unit. Which of these two possibilities is to be preferred depends primarily on the kind of the activating event. It is possible, for example, that a battery electronics monitors the cell voltage of individual cells and transmits the measurement result to a central control unit outside the battery which then in turn generates the signal for activating the protective unit of that cell or those cells and transmits it to the corresponding protective unit or protective units which are associated with the cells to be bypassed.

A particularly advantageous embodiment of a protective unit according to the invention provides an activation unit which can be activated by a signal which is generated by at least one sensor which measures at least one physical variable which indicates the operating state of the battery cell which is associated with the protective unit. Such sensors, for example, can be temperature sensors which are attached to each cell and permanently measure the temperature of their associated cells. Here too, there are again different possibilities to evaluate the measurement result.

It is possible, for example, that a temperature sensor locally generates a signal for activating the protective unit of the cell, the temperature of which the sensor permanently measures. However, it is also possible that a central control unit evaluates the measurement results of these and/or other sensors together, for example temperature and voltage sensors, so as to generate, depending on a plurality of measurement results and by means of a specific decision logic, a signal for activating the protective units of individual cells, which signal is then transmitted to the activation units of the protective units of said cells and initiates there the activation of the respective protective units.

According to a likewise preferred embodiment of the present invention, a protective unit is provided, the activation unit of which can be deactivated upon subsequent omission of the requirements for its activation, whereupon said protective unit reverses the bypass of the associated cell, whereby said cell is integrated again into the battery assembly. The activation unit of the protective unit according to the invention can preferably also be configured in such a manner that for example after cooling the respective cell, the same can be reconnected to the battery assembly. The energy required for this can be taken, for example, from the cell itself which is now functioning again or from the other cells remaining in the battery assembly. During this connection, the energy storage device for activating the protective unit can preferably be charged again.

According to a likewise preferred embodiment of the present invention, a protective unit is provided which is configured in such a manner that it can be arranged between the pole connections of adjacent cells. The FIGS. 3, 4, 8, 10 and 11 show illustrations of such exemplary embodiments of the present invention.

According to a likewise preferred embodiment of the present invention, a protective unit having an activation unit is provided, which activation unit comprises a fuse wire which keeps a wave spring serving as energy storage device in a tensioned state and is activated by a current pulse which melts the fuse wire whereupon the wave spring relaxes and makes the energy required for changing the interconnection available. This mechanical configuration of the energy storage device—for example compared to an external active control of the activation unit—is particularly robust against disturbances and—due to eliminated signal lines—can be produced in a cost-effective manner.

A further advantageous protective unit according to the invention has a housing which is sealed in an airtight manner. Particularly advantageous is a protective unit, the housing of which is filled with an inert shielding gas.

Compared to a housing filled with ambient air, the corrosion protection in case of a suitable selection of the shielding gas is often better.

FIG. 5 shows a battery cell 501 having a protective unit according to the invention. The electrodes 503 and 504 are connected via suitable contact plates 506 and 507 to conductor rails 509. A wave spring 508 changes the position of the contact plate 507 upon activation of the protective unit of the cell 501.

FIG. 6 shows an enlarged illustration of a protective unit according to the invention with the electrodes 603, 604, the wave spring 608 and the contact plates 606 and 607. As shown in FIG. 7, the wave spring 708 is mounted on a bearing 710 which provides that in case of a melting fuse wire 711, the relaxing wave spring can not deflect downwardly, which is the reason why during an activation of the protective unit, the contact plate 707 of the electrode 704 has to push upwardly.

As clearly shown in FIG. 8, prior to the activation, the contact plate 707 or, respectively, 807 contacts the contact plate 806 of the adjacent cell 802. After the activation by melting the fuse wire 811, it contacts the conductor rail 805.

The sectional side views of the FIGS. 9a, 9b and 12a and 12b show the same embodiment of the protective unit according to the invention before and after the activation, respectively. The FIGS. 9a and 12a show the relationship of the sections illustrated in the FIGS. 9b and 12b, respectively.

The following reference numbers were used in the figures for identification of the illustrated details:
201, 301, 801, 1001, 1101, 1201
Galvanic cell, battery cell
202, 302, 802, 1002, 1102, 1202
Galvanic cell, battery cell
203, 503, 603, 1003, 1103, 1203
Electrode, arrester, arrester plate
204, 504, 604, 704, 1104
Electrode, arrester, arrester plate
205, 405, 805, 905, 1005, 1205
Conductor rail, contact element
206, 406, 506, 606, 806, 1106
Contact plate of an electrode
207, 407, 507, 707, 807, 907, 1007, 1107, 1207
Contact plate of an electrode
208, 408, 508, 608, 808, 908, 1008, 1108, 1208
Wave spring
209, 409, 509, 709, 1009
Conductor rail, contact element
910, 1110, 1210
Bearing of the wave spring
911, 1011, 1111, 1211
Fuse wire
212, 1012, 1212
Conductor rail, contact element
1013
Contact plate of an electrode
214, 1014
Contact plate of an electrode
1230
Predetermined breaking point of the fuse wire

### Detail of FIG. 3 Illustrated in FIG. 4

The FIGS. 2, 3, 4, 8, 10 and 11 show exemplary embodiments of a battery from battery cells having protective units according to the invention. Such a battery consists preferably of a plurality of protective units which are arranged between adjacent cells of the battery. Here, a plurality of contact elements is provided for interconnecting a series connection and/or parallel connection of cells of the battery. A first portion of said contact elements is movably arranged; a second portion of said contact elements is immovably arranged. Activating a protective unit of a first cell effects that a movable first contact element, which prior to the activation serves for forming an electrical series connection to an adjacent second cell, is moved upon activation of the protective unit and is pressed against an immovable second contact element, whereby the first cell is bypassed and thus electrically detached from the series connection.

It applies to all exemplary embodiments that bypassing or disconnecting defective cells, controlling the activation unit or similar objects within the context of the practical implementation of the present invention can preferably be carried out by means of semiconductor elements. For example, semiconductor switching elements such as, e.g., thyristors or field-effect transistors (e.g. power MOSFETs) are particularly well suited for such purposes. They can preferably be electrically controlled by a temperature sensor via a control electronics.

1. A protective unit for galvanic cells which are interconnected into a battery via contact elements which are connected in a suitable manner to pole connections of said battery cells,
wherein
the protective unit has an activation unit for activating the protective unit,
upon activation of the protective unit, said protective unit bypasses the associated cell by changing the interconnection and thus detaches it electrically from the battery assembly,
characterized in that
the protective unit comprises a mechanical energy storage device which stores the energy required for changing the interconnection and makes it available upon activation of the protective unit, wherein said energy storage device is kept in its initial position by a fuse wire.

2-3. (canceled)

4. The protective unit according to claim 1, which protective unit can be associated with individual cells of a battery.

5. The protective unit according to claim 1, comprising an activation unit which can be activated by a signal which is generated outside the protective unit.

6. The protective unit according to claim 1, comprising an activation unit which can be activated by a signal which is generated inside the protective unit.

7. The protective unit according to claim 1, comprising an activation unit which can be activated by a signal which is generated by at least one sensor which measures at least one physical variable which indicates the operational state of a galvanic cell which is associated with the protective unit.

8. The protective unit according to claim 7, the activation unit of which can be deactivated upon subsequent omission of the requirements for its activation, whereupon said protective unit reverses the bypass of the associated cell, whereby said cell can be integrated again into the battery assembly.

9. The protective unit according to claim 1, which protective unit is configured in such a manner that it can be arranged between the pole connections of adjacent cells.

10. The protective unit according to claim 1, comprising an activation unit in which
a fuse wire keeps a wave spring serving as energy storage device in a tensioned state, and in which
the activation unit is activated by a current pulse which melts the fuse wire, whereupon the wave spring relaxes and makes the energy required for changing the interconnection available.

11. The protective unit according to claim 1, comprising a housing sealed in an air-tight manner.

12. The protective unit according to claim 11, the housing of which is filled with a shielding gas.

13. (canceled)

14. A battery comprised of galvanic cells and at least one protective unit according to claim 1.

15. The battery according to claim 14, characterized in that
a plurality of protective units is arranged between adjacent cells of the battery,
a plurality of contact elements is provided for interconnecting a series connection of cells of the battery,
a first portion of said contact elements is movably arranged,
a second portion of said contact elements is immovably arranged, and
activating a protective unit of a first cell effects that a movable first contact element, which prior the activation serves for forming a series connection to an adjacent second cell, is moved upon activation of the protective unit and pressed against an immovable second contact element, whereby the first cell is bypassed and thus is electrically detached from the series connection.

16. The protective unit according to claim 7, which protective unit is configured in such a manner that it can be arranged between the pole connections of adjacent cells.

17. The protective unit according to claim 16, comprising an activation unit in which
a fuse wire keeps a wave spring serving as energy storage device in a tensioned state, and in which
the activation unit is activated by a current pulse which melts the fuse wire, whereupon the wave spring relaxes and makes the energy required for changing the interconnection available.

18. The protective unit according to claim 7, comprising a housing sealed in an air-tight manner.

19. The protective unit according to claim 18, the housing of which is filled with a shielding gas.

20. The protective unit according to claim 8, which protective unit is configured in such a manner that it can be arranged between the pole connections of adjacent cells.

21. The protective unit according to claim 20, comprising an activation unit in which
a fuse wire keeps a wave spring serving as energy storage device in a tensioned state, and in which
the activation unit is activated by a current pulse which melts the fuse wire, whereupon the wave spring relaxes and makes the energy required for changing the interconnection available.

22. The protective unit according to claim 8, comprising a housing sealed in an air-tight manner.

23. The protective unit according to claim 22, the housing of which is filled with a shielding gas.
